(19) United States
(12) Patent Application Publication
(10) Pub. No.: US 2013/0085591 A1
(43) Pub. Date: Apr. 4, 2013

(54) METHOD AND ARRANGEMENT FOR FORMING A DENTAL MODEL

(71) Applicant: Thomas Ertl, Ranstadt (DE)

(72) Inventor: Thomas Ertl, Ranstadt (DE)

(73) Assignee: DEGUDENT GMBH, Hanau (DE)

(21) Appl. No.: 13/638,606

(22) PCT Filed: Mar. 28, 2011
(86) PCT No.: PCT/EP2011/054678

§ 371 Date: Nov. 6, 2012

(30) Foreign Application Priority Data
Mar. 29, 2010 (DE) 102010016199.3
May 11, 2010 (DE) 102010016882.3
Jul. 16, 2010 (DE) 102010036436.3

(51) Int. Cl. G06F 17/50

(52) U.S. Cl. CPC G06F 17/50
USPC 700/98

(57) ABSTRACT

The invention relates to a method for forming a physical or virtual dental model as an aid to the production of a dental prosthesis taking account of the shape of at least one tooth stump present in an upper or lower jaw, of points of contact with the teeth adjacent to the at least one tooth stump, and of the occlusal surface of at least one opposing tooth in the region of the field of movement of the dental prosthesis to be disposed on the at least one tooth stump using digital data relating to the upper and lower jaw measured in a contact-free manner.

The invention relates to a method for forming and manufacturing a physical or virtual dental model as an aid in the production of a dental prosthesis, whereby one takes into account the shape of a tooth stump present in either the upper or lower jaw, contact points to teeth adjacent to the at least one tooth stump, as well the occlusal surface of at least one antagonist tooth in the field of motion of the dental prosthesis to be provided on the at least one tooth stump, using digital data of the upper and lower jaw obtained by contact-less measurements.

A multitude of arrangements and methods for the manufacture of dental prostheses are known in the art. In general, subsequent to the dental preparation, one creates an impression of the tooth stump that will accept the dental prostheses, as well as of its surroundings and the jaw. The same applies in the case where several tooth stumps are to be provided with dental prostheses. Irrespective hereof, this is usually performed using a silicone-casting compound, even though other materials may be used.

From the imprint, which represents this situation in the patient's mouth in negative form, one prepares a so-called master model via a plaster cast. This model represents the situation in the patient's mouth in positive form. A dental technician uses his craft skills and this model to mold a model of the skeletal structure of the dental prostheses using wax or a plastic curing by polymerization at low temperature. A positive mold created in this manner usually is used as a basis for the dental prosthesis.

In the present day, however, the old-fashioned plaster mould is produced using new technologies (stereo lithography or milling) and new materials (plastic) from stereo lithography data sets of the occlusion pattern in combination with a digital representation of the tooth base. In this, removing the prepared dental stumps, for example, from the remaining model is intended and is realized using various connecting structures. A purely statistical final occlusion position is available by encoding the model of the upper and lower jaws by means of connecting structures.

A disadvantage of the presently available method for realizing this is the high requirements for material, which for plaster casts is not an issue, but with the expensive plastic materials, which are required for stereo lithography or comparable processes, leads to cost-related disadvantages that limit their competitiveness. One also faces a comparatively long manufacturing time of several hours, which in combination with the high investment costs for rapid prototyping machines results in a high cost burden.

DE-B-10 2005 033 738 relates to a method and a device for the manufacture of dental prostheses. In this, existing design data are shown on a display together with measured data of a machined dental prosthesis to be manufactured.

The subject matter of DE-A-10 2006 026 776 is a method for the manufacture of a dental prosthesis, whereby one digitally acquires information on the configuration and relative positions of the jaws.

In accordance with DE-A-103 04 757 the manufacturing of dental prostheses takes into consideration data about the jaws that normally are collected from patients during the process of adjusting an articulator. In addition, jaw movements are simulated in a computer.

The manufacture of dental prostheses with the help of virtual prototypes is disclosed in EP-A-1 935 369. For this, one scans a jaw region, into which the dental prosthesis is to be implanted.

WO-A-2008/051130 relates to a method and a device for the manufacture of a dental model with the help of impressions.

Known from WO-A-2008/030965 is a method for the manufacture of a dental prosthesis, in which one uses a virtual model of the upper and lower jaws.

The manufacture of a dental prosthesis with help of a virtual prosthesis is described in WO-A-03/017864, whereby one records 3D data of an upper or lower jaw, into which the dental prosthesis is to be implanted.

US-A-2005/0070782 describes the manufacture of dental prostheses with the help of virtual models. This also involves the use of a virtual articulator.

The present invention is based on the objective to further develop and make available a method and an arrangement of the above-mentioned type in a way that facilitates a production with reasonable costs, for example in rapid prototyping production, whereby at the same time diagnostic information that can be obtained from the patients is to be incorporated into the manufacturing process.

With respect to the method, this objective fundamentally is met by following at least the following procedural steps:
a) scanning the upper and lower jaw to acquire first data,
b) recording the field of motion of the temporomandibular joint during disclusion to acquire second data,
c) recording the contact field of the teeth during occlusion to acquire third data,
d) computing the paths of motion between the upper and lower jaws from at least the first data and the third data or the first and the second data or the second and the third data or the first and the second and the third data,
e) employing a retaining device comprising a lower part and an upper part adjustable relative to the lower part, whereby connected or being connected to the upper part is a first element representing the upper jaw and comprising first receptacles and connected or being connected to the lower part is a second element representing the lower jaw and comprising second receptacles,
f) producing three support points or support surfaces, which are formed by the paths of motion, which are computed in accordance with step d) and which have been or are being arranged stationary relative to the lower part and upon which is supported the upper part via supporting elements,
g) producing the at least one stump as well as at least one facing side of the neighboring teeth as well as the occlusion surface of the at least one antagonist tooth, and arranging these in the first and second receptacles while taking into account the first, second, and third data, and
h) manufacturing the dental prosthesis on the at least one stump,
   whereby either the procedural step b) or the step c) is carried out or both the procedural step b) and the procedural step c) are carried out.

The procedural steps e), f), g), and h) may be performed in a virtual manner.

With respect to procedural step c), the occlusion should be recorded in the centric position and with the perimetric field of motion. It is also possible to record the occlusion in step c) with therapeutic correction. Also possible is a forced performance of the occlusion in procedural step c).

As a further development of the invention it is intended that the resiliency field of the temporomandibular joint and/or mandible and/or dental apparatus in order to acquire fourth data, whereby the resilience of the support points or surfaces is embodied taking into account the fourth data.

Furthermore, in a variant it is intended that associated with the supports have been or will be travel limiters, which serve to restrict the movement of the upper part relative to the lower part in accordance with the jaw movement and/or the measured resiliency field of the temporomandibular joint, whereby in particular the jaw movement is determined at least in accordance with procedural step b).

It is further possible to additionally measure the resiliency of the periodontium of at least one tooth to determine fifth data, which are taken into account at least in procedural step d).

Irrespective hereof, instead of procedural step c), one may use lateral movements of the lower jaw relative to the upper jaw and a method computing the minimum increase of potential energy during the movements to determine sixth data, which replaces the third data.

The invention also is characterized by the fact that the computation of the support points or support surfaces—from at least the first and third data or alternatively from the sixth data—in accordance with procedural step f) is performed using fewer degrees of freedom of the lower jaw relative to the upper jaw, whereby a rotation about the sagittal axis (x axis), a rotation about the transverse axis (y axis), and a translation along the z axis at right angles to the occlusion plane are excluded.

As a starting point for the computation of the lateral movement, one may choose the centric position of the upper and lower jaw.

To determine the centric position of the upper and lower jaws, one should scan the buccal side surface of the teeth of the upper and lower jaws in the terminal occlusion position.

Acquisition of the first, second, and third data takes place intra-orally.

In accordance with the invention it is possible that not only a physical retaining device is produced and a real production of a stump in oral surroundings, i.e. of the neighboring teeth and one or several antagonists, or parts thereof, takes place, but that also the jaw regions required for the manufacturing of the dental prosthesis are generated virtually and the dental prosthesis is produced virtually—taking into account the data acquired by the scanning of the upper and lower jaws—and that subsequently the data corresponding to the virtual dental prosthesis are used to produce the dental prosthesis in a CAM process, as is already done in CAD/CAM processes known in the art.

In accordance with the invention it also is possible to simulate the modules of elasticity of the individual anatomical structures, which for example are caused by the elastic suspension of the teeth provided by the periodontium. One also may take into account the module of elasticity of the temporomandibular joint. This prevents errors in the determination of the occlusal and interproximal contacts.

In dependence on the scope of the data acquisition performed at the patient, the invention offers several options.

For example, one starts by means of scanning or an equivalent no-contact method, such as in the system available under the name Zebris, a record of the field of motion of the temporomandibular joint in disclusion, i.e. one determines the volume available for movements in the absence of an occlusion. In this, the field of motion may be determined in a forced or in an unforced manner.

In this, the unforced performance data of the available volume of movement is defined by the anatomical and pathological limitations of the two temporomandibular joints, by both the joint articulation and the limits of the ligaments. In the unforced determination of performance data, the patient himself performs free jaw movements without contact, i.e. in disclusion, and in particular movements at the extreme limits as well as movements throughout the available volume, in order to fill in the performance data within the limits of motion.

The actual physiological rest position defined by the muscle action is obtained by obtaining data over a period of time sufficient for the deviations in the sequence of measurement data to stabilize.

In addition or as an alternative, a movement can be forced. This is achieved by a dentist guiding the lower jaw. This is often necessary to collect a sufficient amount of required data since many patients are not able to correctly perform terminal occlusion or excursion movements—without help. If the lower jaw is guided in a moderate manner, the set movements due to the action of the dentist may be acceptable.

From the different measurements, i.e. the difference between the fields of motion of the forced and the unforced procedure, one additionally may draw conclusions about muscular malfunctioning.

In the determination of the physiological rest position as well, a moderate degree of guiding into a retral contact position or a position in close vicinity thereto may be practical.

Irrespective hereof, digital 3D data of the lower and upper jaw must be determined in any case.

Subsequently, after determining the field of motion of the temporomandibular joint in disclusion—in as far as this step is performed—one determines the dental contact field during occlusion, whereby the patient moves the lower jaw with minimal chewing effort in occlusion relative to the upper jaw, so that the entire occlusion region is determined. The occlusion characteristics thus are stored as mapping data. Data obtained in the determination of the dental contact field during occlusion consequently comprises the upper and lower jaw in centric position and a field of movement extending around the centric position.

If necessary, the field of movement can also be determined with therapeutic correction, i.e. with an adjustment of the bite position, e.g. by means of an occlusal splint in preparation of an occlusion correction in case of pathological occlusion findings. However, a therapeutic correction of the occlusion also may be detected with a retainer in place, e.g. in preparation of a bite elevation. Interferences may be determined in a comparison to the data obtained without the retainer.

Instead of using the field of motion of the temporomandibular joint in occlusion one has the option—as an alternative or in addition—to use the data determined in the centric position of upper and lower jaw to compute possible laterally shifted positions of the lower jaw relative to the upper jaw, by using a method that takes into account the minimum increase of the potential energy. In this, the increase in potential energy is computed for infinitesimal motions along a given direction. As mentioned above, the movement commences in the centric position, which as absolute minimum represents the smallest distance between the centers of gravity of the upper jaw and the lower jaw. Concatenating such infinitesimal steps of movement with minimum increase in energy yields the most likely relative movements, but ignores the influence of the temporomandibular joints, which is acceptable however in the immediate vicinity of the centric position. One restriction on the possible paths of motion is the ligamentary restriction, i.e. the limits imposed by the ligaments and cartilage of both temporomandibular joints. This can be assumed in the mean by estimating a most likely position of the condyles and the dental arches and can also be measured by means of jaw registration (Field of movement during occlusion and disclusion).

The occlusion geometry for the upper and lower jaws is determined independent of the applied method, be this measuring of the field of movement of the temporomandibular joint in disclusion and occlusion or the determination of the paths of motion using the method of minimum potential energy increase, by means of intra-oral scanning and will be available in digital form. In this one can infer the relation of the lower jaw and upper jaw with respect to each other from the data of the buccal scan of the lateral side surfaces of the teeth in contact or a scan of a check-bite.

If the fields of motion are determined in a measuring fashion, then in another different and inventive variant of the invention one takes into consideration the resiliency characteristics. In this, the resiliency field may take into account the elasticity of temporomandibular joints and mandible, and additionally the resiliency of the periodontium of one tooth or several teeth.

To determine the resiliency of temporomandibular joints and mandible the patients carries out the same movements that would be performed during the recording of the dental contact field during occlusion, this time however with chewing forces corresponding to those applied in regular chewing. This is achieved by letting the patient chew a partially elastic medium such as chewing gum. Because of the chewing forces being applied in this, the occlusion system is deformed in accordance with the respective modules of elasticity of the involved anatomical structures. Of supreme relevance in this are temporomandibular joints, mandible, and periodontium.

As mentioned above, these data may be supplemented by measurements of the resiliency of other teeth, which are determined by the force-distance profile along one spatial direction or are approximated by means of pulse forced response measurements. A device suitable for this is the commercially available Periotest system.

The data obtained in this manner can be related/associated with the data that have been determined by the recording of the dental contact field during occlusion, in order to detect relevant deformations that would be taken into consideration during the manufacture of the dental prosthesis.

This provides possibilities unknown in the present state of the technology, since the resilience of the temporomandibular joints or resilience of individual teeth, i.e. the resilience of the periodontium is not known in the methods known in the art, and more importantly their incorporation is not possible. This will result in the loss of a significant portion of the information, which prevents an optimization of the dental prosthesis and can result in the performance of grind-to-fit measures at the patient, in order to compensate for the inaccuracies caused by the missing data.

A system available under the Zebris name may be used for the purpose of determining the field of motion of the temporomandibular joint and the dental contact field during occlusion or disclusion.

With respect to the resiliency data for the temporomandibular joints, the mandible, and the periodontium, it should be noted that these on principle are obtained only as a whole for the entire jaw using conventional systems.

If a dental prosthesis is to be manufactured using a real model, i.e. if a dental technician is to perform manual processing steps, then in addition to a digital process chain starting with an intra-oral digital data acquisition of the above-described type one must additionally provide a real aid with a functionality at least equivalent to the plaster models presently in use.

For this it is mandatory that the following functions and characteristics be known:
Shape of the prepared dental stump or of the prepared dental stumps,
Contact points to the neighboring teeth,
Chewing surfaces of the antagonist teeth within the limits of the field of motion of the prepared tooth or teeth,
Possibility of placing upper and lower jaw into the centric position.

According to the invention, other information is available, in particular relating to:
Dynamic occlusion, either arbitrary (as a mean) or individually.

Furthermore, according to the invention's teaching, data can be provided that relates to:
Resiliency characteristics of at least one element out of the group comprising: temporomandibular joints, dental suspension in the bone, mandible, and periodontium.

Also considered may be values concerning:
Modulus of elasticity of the bone,
   which are obtained from the literature.

It is also necessary to define axes, whereby one usually defines:

X axis: sagittal axis

Y axis: transverse axis

Z axis: perpendicular to the occlusion plane

In order to be able to produce a dental prosthesis at reasonable cost when using the new methods and the new materials, as they were described above, whereby additionally one dispenses with the conventional method of impressions in the data acquisition process and carries out contact-free scanning instead, one key point to realize cost savings will be the minimization of required construction volume, material, and construction time. While retaining the necessary optional properties, this will be made possible by using the above-described data extraction performed at the patient as well as the computation of the likely paths of motion, as was described above.

Along these paths of motion, certain movement options are ruled out by dental contacts between the lower jaw and the upper jaw as well as by a reduction of the degrees of freedom (rotation about the X axis and Y axis and translation along the direction of the Z axis). The sliding motion of the lower jaw in dental contact with the upper jaw, which corresponds to the measured dental contact field during occlusion, consequently can be described using three points of the coordinate system of the lower jaw and the coordinate system of the upper jaw.

This provides independence from the disclusion of the jaw movement away from the centric position forced by the dental contact, since the necessary information is present in the characteristics of the movements of the jaws relative to each other, which relates to the dental contact field in occlusion—without necessarily having to take into account the resiliency characteristics—including the information from the temporomandibular jaw.

As a result of this, one could theoretically reproduce the characteristics of the movement in dental contact even if no teeth were present at all, if each of these three points is guided along a surface that precisely corresponds to the surface that these points would have traveled in dental contact.

Consequently, one now has the option to use in a physical model only the geometrical information that is necessary for the design of the dental prosthesis, without having to abandon the complete statistical and dynamical occlusion information.

In a practical application this is realized via three fields of motion, which are comparable to the guideways of a conventional articulator but as a result of the teachings of the invention contain the complete information on the movement of the lower jaw relative to the upper jaw in dental contact.

If one simplified further, at the cost of certain disadvantages, it would even be possible to concentrate the three fields of motion into points, and to construct a dental prosthesis in this manner.

Irrespective thereof, in embodying the invention it is intended that the movement-limiting function of the temporomandibular joint is included, in particular by so called so-called travel limiters, which are associated with the three-point supports.

The fields of motion and the limiters are individual component parts that can be manufactured in a rapid prototyping process. Receptacles of at least the fields of motion are prefabricated in a retaining device.

For example, for the manufacturing of an individual crown one only requires the prepared tooth stump, a section of the interproximal surfaces of the adjacent teeth facing the tooth stump, as well as a section of the occlusal surface of the antagonist teeth that is sufficiently large to cover the range of movements. The interproximal surfaces and the occlusion surfaces of the antagonist teeth may be produced using transparent material in order to facilitate direct observation of the contact points.

The individual components, i.e. the tooth stump, adjacent teeth, i.e. their interproximal surface sections, and antagonist teeth, i.e. their occlusional surface sections, subsequently are assigned to each other in accordance with the determined data. For this, the physical embodiment of the model to form the dental prosthesis using physical individual components makes use of a retaining device with a lower part and an upper part adjustable thereto, whereby used with the upper part is a first element representing the upper jaw with first receptacles and used with the lower part is a second element representing the lower jaw with second receptacles. The relationship between the first and second elements with respect to the first and second receptacles for the individual components is determined from the scanned data.

The receptacles may be mounted as pin/hole patterns or crosshatched patterns on base plates serving as the first and second elements.

Consequently it becomes possible to minimize the consumption of materials as well as the necessary footprint and height of the individual component parts.

It should also be emphasized that the invention's teaching, i.e. the use of minimized individual component parts, provides the possibility to be “entirely backwards compatible” to conventional technology. Starting from the described minimum configuration, one has the option to add for example entire neighboring teeth or entire antagonist teeth, all the way to two complete jaws. In this case, the occlusion information provided by conventional teeth will not be transferred into the fields of motion. Consequently one achieves scalability of a complete representation of the characteristics of the temporomandibular joints and the occlusion in the three fields of motion or sliding fields all the way up to complete models with all teeth, whereby only the temporomandibular jaw information is represented by the sliding fields.

It now becomes possible to provide a quadrant model with the full functionality of a full pair of upper and lower models.

One also gains capability to develop the fields of motion in a manner replicating the measured resiliency.

Thus it is possible to map the resiliency in a mechanical articulator system. This may be realized by manufacturing the fields of motion from a material that matches the measured resiliency. But preferably one uses a component as the field of motion that consists of at least two parts, one of which possesses a high elasticity. By varying the layer thickness, the resilience may be adjusted individually, in particular in accordance with the data measured at the patient.

As a result of the invention's teaching one has available a physical model, which possesses a functional usability that is at least equal to that of conventional models but which only comprises those model components that are absolutely necessary to manufacture the dental prosthesis. Especially the savings with respect to construction time and material consumption should be emphasized, in particular if the manufacturing is accomplished using a rapid prototyping process.

The invention's teaching can also be realized in a purely virtual manner, so that one obtains in accordance with the above-described procedure a data set for the dental prosthesis, whereby the prosthesis subsequently is produced in a CAM process.

The invention also is characterized by an arrangement for manufacturing a dental prosthesis, comprising one retaining device with a lower part and an upper part, which is adjustable relative to the latter and which is supported on the support points or support surfaces, which are situated in the regions of the corners of a triangle, which are arranged stationary relative to the lower part or originate in the lower part, whereby the upper part comprises a mount for a first element representing the upper jaw with first receptacles, and the lower part comprises a mount for a second element representing the lower jaw with second receptacles, whereby in the first and second receptacles are arranged at least one tooth stump to be equipped with the dental prosthesis, at least the facing side surfaces of teeth adjacent to the tooth stump, and the occlusal surface of at least one antagonist tooth, whereby the support points or support surfaces, the assignment of the first and the second receptacle as well as the positions of the at least one tooth stumps and the facing lateral surfaces and the occlusal surface are computed on the basis of data that were determined by means of intra-oral measurements of lower and upper jaws, and at least in the centric position of the jaws.

In this, it is in particular intended that one uses as data those that in accordance with the invention's method were determined intra-orally by recording the upper and lower jaws and the field of motion of the temporomandibular joints in disclusion and the contact field of the teeth during occlusion, whereby the data concerning the dental contact field during occlusion may be replaced by the data computed using a method to minimize the increase of potential energy during the movements from lateral movements of the lower jaw relative to the upper jaw.

It is further intended that the support surfaces be surfaces of a body connected to the lower part, with local elasticities that correspond to the sum elasticities (resiliency) of the temporomandibular joints and the periodontia of the respective teeth pairs in occlusal dental contact recomputed for the respective support positions.

It is also possible for the supports of the upper part to contain limiting elements that take into account the limits of movement of the jaw. The equivalent applies with respect to the resiliency of the jaw, so that the limiter elements possess a corresponding elasticity.

Further details, advantages, or features of the invention are not only found in the claims and the characteristic features contained therein—on their own and/or in combination—but also in the following description of preferred embodiment variants illustrated in the figures.

FIG. 1 shows an arrangement for manufacturing a dental prosthesis,

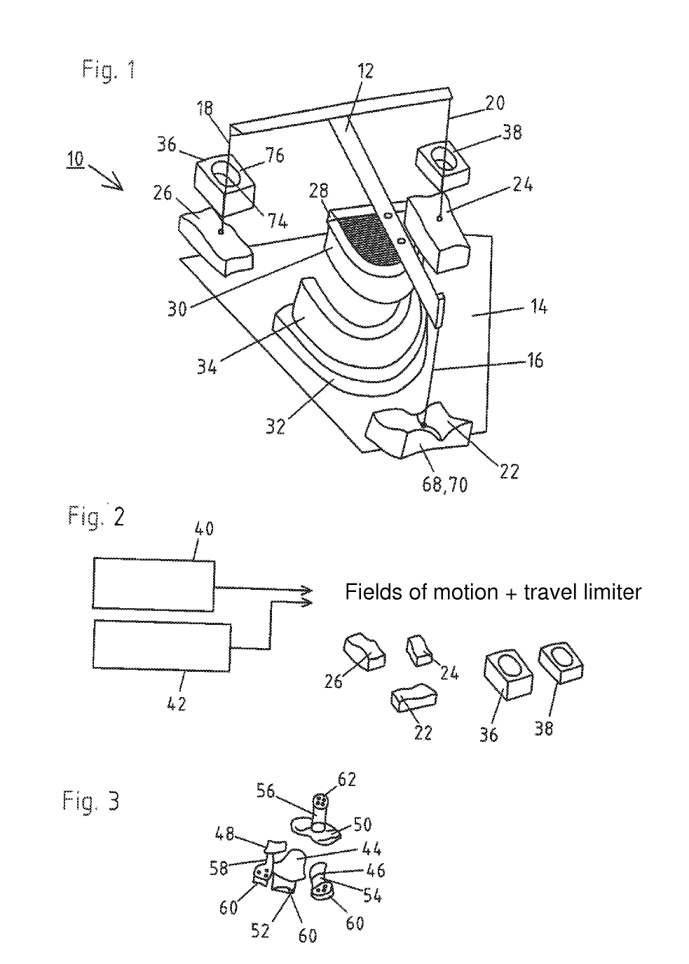

FIG. 2 shows a schematic illustration of the invention's method,

FIG. 3 shows a schematic illustration of individual components for manufacturing a dental prosthesis,

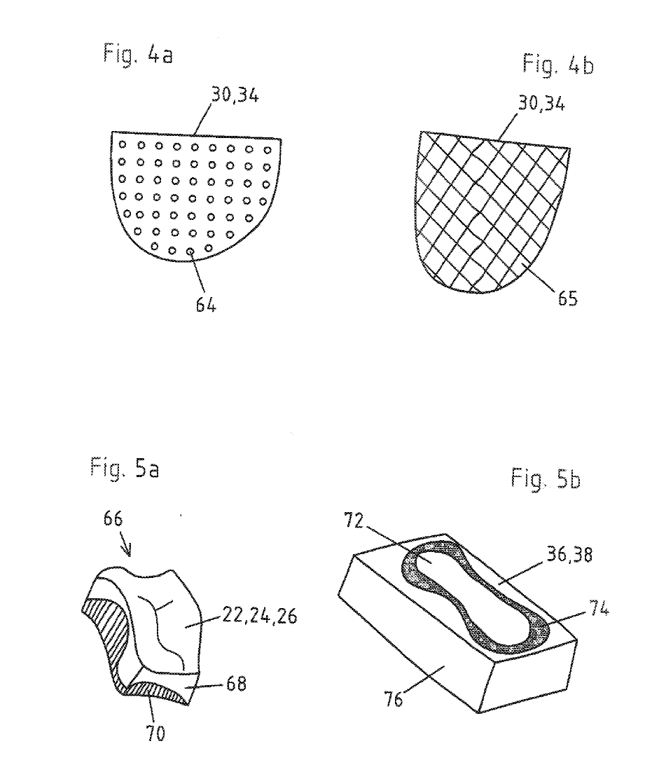

FIGS. 4a, 4b show base plates to accommodate individual components,

FIGS. 5a, 5b show schematic illustrations of fields of motion and travel limiters.

In accordance with the teaching of the invention, one intra-orally measures the upper and lower jaws of a patient in order to obtain digital 3D data for the purpose of manufacturing a dental prosthesis. Subsequently one measures at least the tooth contact field during occlusion, i.e. in the centric position of the upper and lower jaw, as well as an extensive field of motion adjacent to the centric position, preferably intra-orally as well. From a buccal scan of the lateral surfaces of the teeth in contact or from the scan of a check-bite, i.e. of an element, such as a silicone element, arranged between the lower jaw and upper jaw positioned on top of each other, one obtains the positional relation of the upper and lower jaws in the centric position. The data relating thereto, possibly taking into account data relating to the field of motion of the temporomandibular joint in disclusion as well as the resiliency field during forced occlusion, possibly additionally taking into account the resiliency of individual teeth in accordance with the explanations provided above, are used to manufacture fields of motion using a rapid prototyping process. Instead of the data resulting from the dental contact during occlusion and the field of movement surrounding the centric position, one may also employ a method of minimum increase in potential energy starting from the centric position of the lower and upper jaw.

In the manufacture of the dental prosthesis one uses an arrangement 10 that comprises an upper part 12 and a lower part 14, whereby the upper part 12 is supported in a sliding manner via three supports 16, 18, 20 upon fields of motion 22, 24, 26, which are arranged stationary relative to the lower part 14, in particular on or in the latter. Preferably, the supports 16, 18, 20 possess ends with a spheroid or paraboloid shape, to be able to slide to the required degree on the fields of motion 22, 24, 26.

Attached to the upper part 12, is a holding plate 28 for a first element 30 representing the upper jaw, and attached to the lower part 14 is a holding plate 32 for a second element 34 representing the lower jaw.

Further, at least two of the supports 16, 18, 20 (supports 18,20 in the embodiment example), are surrounded by travel limiters 36, 38 that reproduce the limitations of the temporomandibular joint, i.e. limits imposed by ligaments and cartilage.

In accordance with the above-described measures pursuant to the invention one uses digitized measuring data and a reduction of the number of degrees of freedom, i.e. preferably by excluding the rotation of the lower jaw about the sagittal axis and the transverse axis and the translation perpendicular to the plane of occlusion, to describe the sliding motion of the lower jaw in dental contact with the upper jaw using 3 points of the coordinate system of the lower jaw in the coordinate system of the upper jaw. This motion is realized by allowing the upper part 12 to slide relative to the lower part 14 by supporting the support elements 16, 18, 20 in the fields of motion 22, 24, 26, which can also be referred to as support points or support regions. In this, the support points are situated at the corners of a triangular column, ensuring a unique supported positioned.

FIG. 2 illustrates the principle that the analysis of the motion of the lower and upper jaw that is measured using intra-oral scanning is used in the above-described manner (data 40), i.e. taking into consideration at least the digital 3D data of the upper and lower jaws and the occlusion in centric position and the adjacent field, to compute the fields of motion 22, 24, 26 as well as the travel limiters 36, 38 in order to subsequently use the corresponding digital data in a rapid prototyping process to produce the corresponding component parts that comprise the fields of motion 22, 24, 26 and the motion limiters 36, 38.

Alternatively, the respective component parts may also be determined on the basis of the data resulting from the scanning of the lower and upper jaws as well from the lateral movement of the lower and upper jaw when using the minimum-increase-of-potential-energy method when the centric position is known (data 42).

FIG. 3 illustrates the individual minimized design of the components needed for the manufacturing of the dental prosthesis. In particular, the components are: the prepared tooth stump 44, shells or shell-like elements 46, 48, available contact surfaces of teeth adjacent to the tooth stump as well as a shell-shaped component 50, which reproduces the geometry of the antagonist teeth. The corresponding component parts are subsequently spatially arranged relative to each other using the corresponding digital 3D data, by arranging them in the spatially coordinated receptacles of the first and the second element 30, 34, which represent the upper and lower jaw.

Starting from the above-explained minimal set consisting of the shell elements 46, 48 and the tooth stump 44 the illustrated dental geometry can be extended all the way to a full model, if for example a dental technician desires to utilize die curvature information of a buccal surface of the adjacent teeth.

Each of the elements 44, 46, 48, 50 possesses a joining element 52, 54, 56, 58 such as a peg, so that it can be arranged positionally accurate in the receptacles of the first and second elements 30, 34. A hole/pin arrangement is suitable for the purpose of seating and fixing the elements and a section thereof is illustrated in FIG. 3 whereby it is labeled by the reference label 60 for the lower jaw and the reference 62 for the upper jaw.

As FIGS. 4a and 4b illustrate, the first and second elements 30, 34, which also can be referred to as base plates, are provided with a hole/pin pattern 64 or a crosshatched pattern 65, which serve as receptacles for the connecting elements 52, 54, 56, 58 of the tooth elements 44, 46, 48, 50. The joining may be achieved via suitable friction-held mortising concepts.

According to the invention it also is possible for the fields of motion 22, 24, 26 and the motion limiters 36, 38 to replicate resiliencies that were measured additionally. In order to realize this constructionally, the components comprising the fields of motion 22, 24, 26 should be designed accordingly with respect to their materials. This is illustrated in principle in FIG. 5a. For example, a component 66 comprising the field of motion 22, 24, 26 as its surface consists of material layers 68, 70, of which the lower layer 70—the layer that does not comprise the field of motion 22, 24, 26—possesses an elasticity that allows yielding to the required degree during the movements of the support elements 16, 18, 20 on the fields of motion 22, 24, 26, which matches the resilience.

Using individual layer thicknesses, which are computed form the data obtained at the patient, one can consequently represent the individual resiliency characteristics of the temporomandibular joint all the way to the resilience of individual teeth.

The equivalent applies to the travel limiters 36, 38, which comprise a recess 72, through which the rod-shaped supports 18, 20 pass and which is bordered by a layer 74 of the desired elasticity, in order to emulate the restrictions of ligaments and cartilage of the temporomandibular joint. The layer 74 is contained in an outer body 76.

On the basis of the invention's teaching and the possibility to use minimal components to model jaw regions that are to be equipped with a dental prosthesis, one achieves significant advantages with respect to materials compared to conventional methods in which a complete model of the lower and upper jaw, as well as a quadrant model are needed. The material savings with regard to the required height of the tooth components are 62% compared to a complete model and 70% compared to a quadrant model. The volume and thus material savings are 98% compared to a complete model and 92% compared to a quadrant model 92%.

List of reference symbols

10 Arrangement
12 Upper part
14 Lower part
16 Support
18 Support
20 Support
22 Field of motion
24 Field of motion
26 Field of motion
28 Holding plate
30 First element
32 Holding plate
34 Second element
36 Travel limiter
38 Travel limiter
40 Data
42 Data
44 Tooth stump
46 Shell element
48 Shell element
50 Component part
52 Connecting element
54 Connecting element
56 Connecting element
58 Connecting element
60 Hole/pin arrangement
62 Hole/pin arrangement
64 Hole/pin arrangement
65 Cross-hatched pattern
66 Component part
68 Material layer
70 Material layer
72 Recess/Groove
74 Layer
76 Outer body

1. A method for forming a physical or virtual dental model, as an aid in the manufacture of dental prosthesis, as well as its manufacture, whereby the shape of at least one tooth stump present in an upper or lower jaw, contact points to teeth adjacent to the at least one tooth stump, as well as the occlusal surface of at least one antagonist in the range of the field of motion of the dental prosthesis to be placed onto the at least one tooth stump are taken into consideration using digital data of the upper and lower jaws measured in a contact-less manner, characterized by at least the procedural steps:
a) recording the upper and lower jaw to acquire first data,
b) recording the field of motion of the temporomandibular joint during disclusion to acquire second data,
c) recording the contact field of the teeth during occlusion in the centric position with ambient field of motion to acquire third data,
d) computing paths of motion between the upper and lower jaws from at least the first data and the third data or the first data and the second data or the second data and the third data or the first data and the second data and the third data,
e) use of a holding device with a lower part and an upper part adjustable relative to the lower part, whereby connected to the upper part has been or is a first element, which represents the upper jaw and comprises first receptacles and to the lower part has been or is being connected a second element, which represents the lower jaw and comprises second receptacles,
f) manufacturing of three support points or support surfaces, which are formed by the paths of travel computed pursuant to step d) and which have been or are being disposed stationary relative to the lower part or upon which is supported the upper part via supporting elements,
g) manufacturing the at least one stump as well as at least one facing side of the neighboring teeth as well as the occlusion surface of the at least one antagonist tooth and arranging these in the first and second receptacles, taking into consideration the first, second, and/or third data, and
h) manufacturing the dental prosthesis on the at least one stump,
whereby either the procedural steps b) or the step c) is performed or both the procedural step b) and the procedural step c) are performed.

2. The method of claim 1, characterized in that
the procedural steps e), f), g), and h) are carried out in a virtual manner.

3. The method of claim 1,
characterized in that
the occlusion in step c) is recorded with a therapeutic correction.

4. The method of claim 1,
characterized in that
the occlusion in the procedural step c) is conducted in a forced manner.

5. The method of claim 1,
characterized in that
one records the resiliency characteristics of the temporomandibular joint and/or mandible and/or dental apparatus to acquire fourth data, whereby the resiliency of the support points or surfaces is embodied taking into account the fourth data.

6. The method of claim 1,
characterized in that
travel limiter elements have been or are being associated with the supports, and are used to limit the movement of the upper part relative to the lower part, in accordance with the jaw movement and/or the resiliency field of the temporomandibular joint, whereby preferably the jaw movement is determined in accordance with procedural step b).

7. The method of claim 1,
characterized in that
additionally one measures the resiliency of the periodontium of at least one tooth for the purpose of determining fifth data, which are taken into account at least in procedural step d).

8. A method for forming a physical or virtual dental model, as an aid in the manufacture of a dental prosthesis, as well as its manufacture, whereby the shape of at least one tooth stump present in an upper or lower jaw, contact points to teeth adjacent to the at least one tooth stump, as well as the occlusal surface of at least one antagonist in the range of the field of motion of the dental prosthesis to be placed onto the at least one tooth stump are taken into consideration using digital data of the upper and lower jaws measured in a contact-less manner, characterized by at least the procedural steps:
a) recording the upper and lower jaw to acquire first data,
b) recording the field of motion of the temporomandibular joint during disclusion to acquire second data,
c) recording the lateral motion of the lower jaw relative to the upper jaw using a minimum-increase-of-potential-energy method during the movements to determine sixth data is computed,
d) computing paths of motion between the upper and lower jaws from at least the first data and the sixth data or the first data and the second data or the second data and the sixth data or the first data and the second data and the sixth data,
e) use of a holding device with a lower part and an upper part adjustable relative to the lower part, whereby connected to the upper part has been or is a first element, which represents the upper jaw and comprises first receptacles and to the lower part has been or is being connected a second element, which represents the lower jaw and comprises second receptacles,
f) manufacturing of three support points or support surfaces, which are formed by the paths of travel computed pursuant to step d) and which have been or are being disposed stationary relative to the lower part or upon which is supported the upper part via supporting elements,
g) manufacturing the at least one stump as well as at least one facing side of the neighboring teeth as well as the occlusion surface of the at least one antagonist tooth and arranging these in the first and second receptacles, taking into consideration the first, second, and/or third data, and
h) manufacturing the dental prosthesis on the at least one stump,
whereby either the procedural steps b) or the step c) is performed or both the procedural step b) and the procedural step c) are performed.

9. The method of claim 1,
characterized in that
computation of support points or support surfaces from at least the first or third data or alternatively from the sixth data in accordance with procedural step f) is performed using fewer degrees of freedom of the movements of the lower jaw relative to the upper jaw, whereby a rotation about the sagittal axis (x axis), a rotation about the transverse axis (y axis), and a translation along the z axis at right angle to the plane of occlusion are excluded.

10. The method of claim 1,
characterized in that
as starting point for the computation of the lateral movement one chooses the centric position of upper jaw and lower jaw.

11. The method of claim 1,
characterized in that
for determining the centric position of the lower jaw and the upper jaw, the buccal side surfaces of the teeth of the upper jaw and the lower jaw are scanned in the terminal occlusion position.

12. The method of claim 1,
characterized in that
the first, second, and third data are acquired intra-orally.

13. An arrangement (10) for manufacturing a dental prosthesis—taking into account diagnostic information for a patient for whom the prosthesis is to be manufactured—comprising a holding device with a lower part (14) and an upper part (12), which is adjustable relative to the upper part, is supported in a sliding manner via supports (16, 18, 20) on three support areas (22, 24, 26), which are situated in regions of the corners of a triangle and are arranged stationary relative to the lower part or originate in the lower part, whereby the upper part comprises a mount for a first element (30) representing the upper jaw with first receptacles and the lower part comprises a mount for a second element (34) representing the lower jaw with second receptacles, whereby in the first and the second receptacles are arranged at least one dental stump (44) to be provided with the dental prosthesis, at least the facing sides of the teeth adjacent to the tooth stump, and the occlusal surface of at least one antagonist, whereby the support surfaces contain information on the movement of the lower and upper jaw in the patient's dental occlusion and the support surfaces, the assignment of the first and the second receptacles, and the positions of the at least one tooth stump as well as the facing lateral surfaces and the occlusal plane are computed on the basis of data, which are determined by means of intra-oral measurements of the upper and lower jaws, and at least in the centric position of the latter, whereby the support surfaces (22, 24, 26) are surfaces of a body (66) connected to the lower part, with local elasticities that correspond to the sum elasticities—recomputed to the respective support positions—of the temporomandibular joints and the parodontia of the respective tooth pairs of the patient that are in occlusional contact, and whereby at least two supports (16, 18, 20) of the upper part are at some distance from the support surfaces (22, 24, 26) encompassed by travel limiters (36, 38) that take into account the limited movements of the patient's jaw.

14. The arrangement of claim 13,
characterized in that
the data are at least the first and third data, or first and second data, or first, second, and third data described in claim 1, whereby the third data may be replaced by the sixth data of claim 9.

15. The arrangement of claim 13,
characterized in that
the limiter element (36, 38) possesses an elasticity that takes into account the resiliency of the jaw.

16. The arrangement of claim 13,
characterized in that
the lateral surfaces of teeth adjacent to the stump (44) and the antagonist teeth are manufactured from transparent material, in order to be able to observe directly the positions of the contact points.

17. The method of claim 8, characterized in that
computation of support points or support surfaces from at least the first or third data or alternatively from the sixth data in accordance with procedural step f) is performed using fewer degrees of freedom of the movements of the lower jaw relative to the upper jaw, whereby a rotation about the sagittal axis (x axis), a rotation about the transverse axis (y axis), and a translation along the z axis at right angle to the plane of occlusion are excluded.

18. The method of claim 8,
characterized in that
as starting point for the computation of the lateral movement one chooses the centric position of upper jaw and lower jaw.

19. The method of claim 8,
characterized in that
for determining the centric position of the lower jaw and the upper jaw, the buccal side surfaces of the teeth of the upper jaw and the lower jaw are scanned in the terminal occlusion position.

20. The method of claim 8,
characterized in that
the first, second, and third data are acquired intra-orally.
